(19) United States
(12) Patent Application Publication
(10) Pub. No.: US 2013/0286919 A1
(43) Pub. Date: Oct. 31, 2013

(54) BASE STATION AND CONTROL METHOD THEREOF

(71) Applicant: Taiga Kawashima, Yokohama-shi (JP)

(72) Inventor: Taiga Kawashima, Yokohama-shi (JP)

(73) Assignee: KYOCERA CORPORATION, Kyoto (JP)

(21) Appl. No.: 13/993,656

(22) PCT Filed: Dec. 20, 2011
(86) PCT No.: PCT/JP2011/079440

§ 371 Date: Jun. 12, 2013

(30) Foreign Application Priority Data
Dec. 20, 2010 (JP) 2010-283598

(51) Int. Cl. H04W 52/02

(52) U.S. Cl. CPC H04W 52/0206
USPC 370/311

(57) ABSTRACT

A base station according to an embodiment comprises: a network communication unit 120 that is capable of communicating with neighboring base stations in the vicinity of the base station; and a control unit 150 that transmits a Cell Activation Request message through the network communication unit 120 to a neighboring base station serving as a handover destination candidate of a radio terminal UE, for requesting return from a power saving state.

### TECHNICAL FIELD

The present invention relates to a base station and a control method thereof in which an SON technology is applied.

### BACKGROUND ART

In LTE (Long Term Evolution) standardized in 3GPP (3rd Generation Partnership Project) that is a standardization body of a mobile communication system, an SON (Self Organizing Network) technology, in which a base station is able to change the setting of the base station without any intervention of manpower, is applied.

As one type of the SON, there is an energy saving technology of reducing power consumption of a base station by stopping the transmission of a radio signal in to the extent having no influence upon communication with a radio terminal (refer to Non Patent Literature 1).

### CITATION LIST

### Non Patent Literature

Non Patent Literature: 3GPP TR36.902 V9.2.0, “Self-configuring and self-optimizing network (SON) use cases and solutions”, 2010-06

### SUMMARY OF THE INVENTION

However, in the aforementioned energy saving technology, since there is no established specific technique when returning a base station from a power saving state to a normal state, the following problem occurs.

Specifically, in the case in which a radio terminal during communication moves to a communication area of a base station in a power saving state, the communication of the radio terminal may be interrupted since the radio terminal is not able to perform handover to the base station.

Therefore, an object of the present invention is to provide a base station and a control method thereof, with which it is possible to appropriately return a neighboring base station to a normal state.

### Solution to the Problem

In order to solve the aforementioned problem, the present invention has following features. First, the feature of a base station according to the present invention is summarized as follows. A base station comprises: a radio communication unit (radio communication unit 110); a network communication unit (network communication unit 120) that is capable of communicating with neighboring base stations in the vicinity of the base station; and a control unit (control unit 150) that transmits a return request (e.g., Cell Activation Request message) to a neighboring base station serving as a handover destination candidate of a radio terminal through the network communication unit, for requesting return from a power saving state.

According to such a characteristic, when the base station detects a radio terminal that performed handover to the base station, the base station transmits the return request for requesting return from the power sating state, to a neighboring base station (a handover destination candidate) designated on the basis of the positional relation between the base station and a neighboring base station serving as a handover source of the radio terminal. In this way, it is possible to appropriately return the neighboring base station to a normal state.

Another feature of the base station according to the present invention is summarized as follows. In the base station according to the feature above, the control unit designates the neighboring base station serving as the handover destination candidate of the radio terminal on the basis of a positional relation between the base station and a neighboring base station serving as a handover source when the radio terminal is handed over to the base station.

Another feature of the base station according to the present invention is summarized as follows. In the base station according to the feature above, the control unit controls the network communication unit to transmit the return request to the neighboring base station serving as the handover destination candidate when the neighboring base station serving as the handover destination candidate is in the power saving state, and controls the network communication unit to omit transmission of the return request to the neighboring base station serving as the handover destination candidate when the neighboring base station serving as the handover destination candidate is not in the power saving state.

Another feature of the base station according to the present invention is summarized as follows. The base station according to the feature above, further comprises: a storage unit that stores location information of each of the neighboring base station and the base station, wherein the control unit acquires location information of the neighboring base station serving as the handover source and location information of the base station from the storage unit, calculates a movement direction of the radio terminal using each of the acquired location information, and designates the neighboring base station serving as the handover destination candidate according to the calculated movement direction.

Another feature of the base station according to the present invention is summarized as follows. In the base station according to the feature above, the network communication unit receives first time information from the neighboring base station serving as the handover source, the first time information indicating a time at which the radio terminal has been handed over to the neighboring base station serving as the handover source, and the control unit further acquires the first time information and second time information indicating a time at which the radio terminal has been handed over to the base station, calculates a movement direction and a movement speed of the radio terminal using location information of the neighboring base station serving as the handover source, location information of the base station, the first time information, and the second time information, and designates a neighboring base station within an estimated movement range of the radio terminal as the neighboring base station serving as the handover destination candidate, the estimated movement range being determined according to the calculated movement direction and movement speed.

Another feature of the base station according to the present invention is summarized as follows. In the base station according to the feature above, the first time information is transmitted from the neighboring base station serving as the handover source before the radio terminal is handed over to the base station and is included in a handover request message for requesting preparation of handover, and the network communication unit receives the handover request message including the first time information from the neighboring base station serving as the handover source.

Another feature of the base station according to the present invention is summarized as follows. In the base station according to the feature above,

The feature of a control method according to the present invention is summarized as follows. A control method of a base station, which includes a radio communication unit, and a network communication unit that is capable of communicating with neighboring base stations in the vicinity of the base station, comprises: a step of designating a neighboring base station serving as a handover source when a radio terminal is handed over to the base station; a step of designating a neighboring base station serving as a next handover destination candidate on the basis of a positional relation between the base station and the neighboring base station serving as the handover source; and a step of transmitting a return request to a neighboring base station serving as a handover destination candidate of the radio terminal, for requesting return from a power saving state.

### BRIEF DESCRIPTION OF THE DRAWINGS

FIG. 1 is a network configuration diagram illustrating a network configuration of a mobile communication system according to the first embodiment.

FIG. 2 is a block diagram illustrating the configuration of the base station according to the first embodiment.

FIG. 3 is a diagram illustrating the configuration of the neighboring base station information according to the first embodiment.

FIG. 4 is an operation concept diagram for explaining a schematic operation of the mobile communication system according to the first embodiment and the second embodiment.

FIG. 5 is an operation sequence diagram for explaining a detailed operation of the mobile communication system according to the first embodiment.

FIG. 6 is a block diagram illustrating the configuration of a base station according to the second embodiment.

FIG. 7 is a diagram illustrating the configuration of a neighboring base station according to the second embodiment.

FIG. 8 is an operation sequence diagram for explaining an operation of the mobile communication system according to the second embodiment.

### DESCRIPTION OF THE EMBODIMENTS

With reference to the drawings, the first embodiment, the second embodiment and other embodiments will be described. In the drawings of each of the embodiments, the same or similar reference signs are applied to the same or similar parts.

In the following each embodiment, a description will be provided for a mobile communication system, which is configured on the basis of LTE (Long Term Evolution) standards having specifications designed in 3GPP (3rd Generation Partnership Project). However, the present invention may be applied to mobile communication systems configured on the basis of other standards.

### (1) First Embodiment

Hereinafter, the first embodiment will be described in the order of (1.1) Overview of mobile communications system, (1.2) Configuration of base station, (1.3) Operation example of mobile communication system, and (1.4) Effect of the first embodiment.

(1.1) Overview of Mobile Communications System

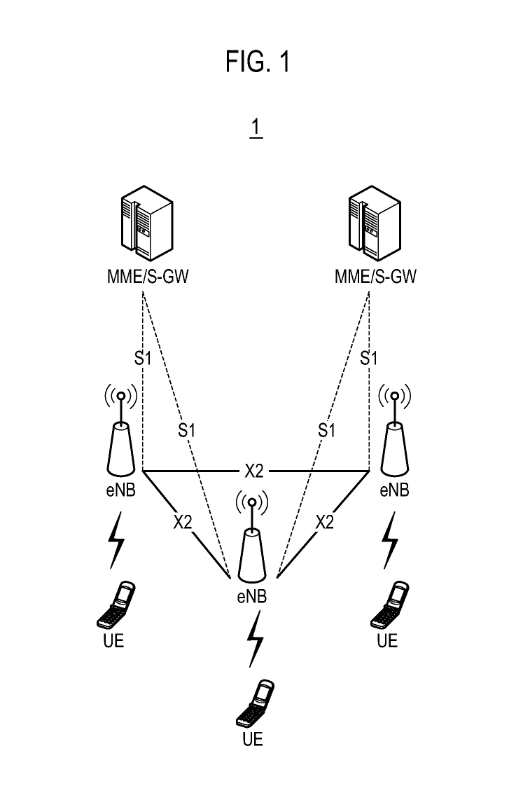

FIG. 1 is a network configuration diagram illustrating a network configuration of a mobile communication system 1 according to the first embodiment. In the mobile communication system 1, an SON (Self Organizing Network) technology is applied.

As illustrated in FIG. 1, the mobile communication system 1 includes a radio terminal UE (User Equipment), a plurality of base stations eNB (evolved Node-B), and a plurality of mobility management devices MME (Mobility Management Entity)/gateway devices S-GW (Serving Gateway).

The plurality of base stations eNB constitute E-UTRAN (Evolved-UMTS Terrestrial Radio Access Network). Each of the plurality of base stations eNB manages one cell or a plurality of cells serving as a communication area where a service should be provided to the radio terminal UE.

The radio terminal UE is a radio communication device carried by a user, and is also called as “User Equipment”. During communication (called RRC Connected), the radio terminal UE is able to switch a serving base station (or a serving cell), that is, to perform handover.

The base stations eNB adjacent to one another are able to communicate mutually via an X2 interface that is a logical communication channel to provide inter-base station communication. Furthermore, each of the plurality of base stations eNB is able to communicate with EPC (Evolved Packet Core), specifically, the MME/S-GW, via an S1 interface.

(1.2) Configuration of Base Station

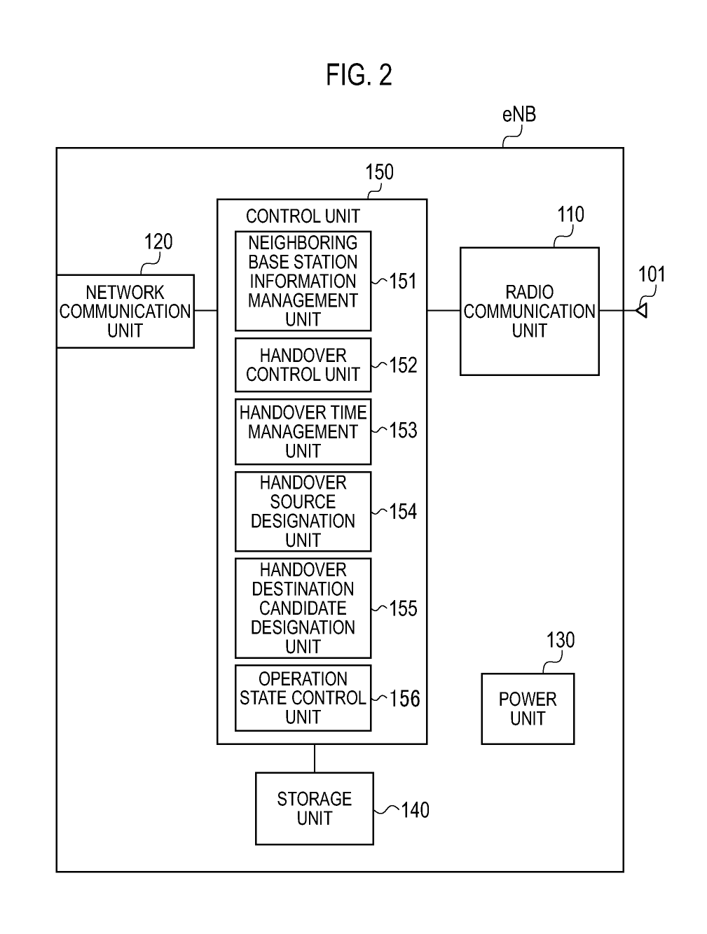

FIG. 2 is a block diagram illustrating the configuration of the base station eNB according to the first embodiment.

As illustrated in FIG. 2, the base station eNB according to the first embodiment includes an antenna 101, a radio communication unit 110, a network communication unit 120, a power supply unit 130, a storage unit 140, and a control unit 150. The antenna 101 is connected to the radio communication unit 110, and each of the radio communication unit 110, the network communication unit 120, and the storage unit 140 is connected to the control unit 150.

The antenna 101 is used for transmitting and receiving a radio signal. The antenna 101 may be configured using a plurality of antenna elements.

The radio communication unit 110, for example, is configured using a radio frequency (RF) circuit or a signal processing circuit, and is configured to perform radio communication through the antenna 101. For transmission, the radio communication unit 110 performs coding and modulation of a transmitted signal that is input from the control unit 150, performs up-converting and amplification for the coded and modulated signal, and then outputs the up-converted and amplified signal to the antenna 101. For reception, the radio communication unit 110 performs amplification and down-converting of a received signal that is input from the antenna 101, performs demodulation and decoding for the amplified and down-converted signal, and then outputs the demodulated and decoded signal to the control unit 150.

The network communication unit 120 communicates with a neighboring base station using the X2 interface. Furthermore, the network communication unit 120 communicates with the MME/SG-W using the S1 interface.

The power supply unit 130 is connected to the radio communication unit 110, the network communication unit 120, the storage unit 140, and the control unit 150, and supplies power to the radio communication unit 110, the network communication unit 120, the storage unit 140, and the control unit 150. The power supply unit 130 is able to stop or reduce the supply of the power to the radio communication unit 110 under the control of the control unit 150. Hereinafter, a state in which the supply of the power to the radio communication unit 110 is stopped or reduced will be referred to as a “power saving state”. Since the radio communication unit 110 is a block having the highest power consumption among the blocks of the base station eNB, when the power supplied to the radio communication unit 110 is stopped or reduced, it is possible to significantly reduce the power consumption of the base station eNB.

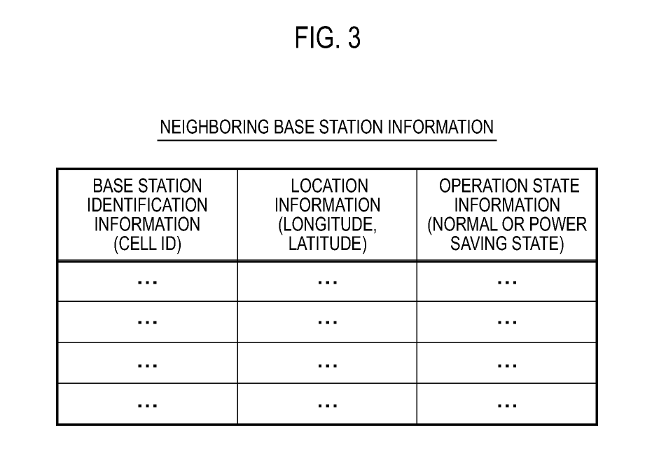

The storage unit 140, for example, is configured using a memory and stores various types of information used for control and the like of the base station eNB. Furthermore, the storage unit 140 stores neighboring base station information on a neighboring base station. FIG. 3 is a diagram illustrating the configuration of the neighboring base station information. As illustrated in FIG. 3, the neighboring base station information is configured such that identification information, location information, and operation state information have been correlated with one another for each neighboring base station. As the identification information of the neighboring base station, a base station ID of the neighboring base station or a cell ID of a cell managed by the neighboring base station may be used. As the location information of the neighboring base station, information on longitude and latitude of the neighboring base station may be used. As the operation state information of the neighboring base station, information indicating whether the neighboring base station is in a normal state or a power saving state may be used. In addition, the storage unit 140 stores in advance location information indicating the location of the self base station eNB.

The control unit 150, for example, is configured using a CPU, and controls various functions provided in the base station eNB. When the control unit 150 detects a radio terminal UE that performed handover to the self base station eNB, the control unit 150 controls the network communication unit 120 to transmit a Cell Activation Request message to a neighboring base station that is a handover destination candidate of the radio terminal UE, the Cell Activation Request message indicating a return request for requesting return from a power sating state. The Cell Activation Request message is transmitted to the neighboring base station using the X2 interface. The Cell Activation Request message includes identification information (specifically, a cell ID) of a base station to be switched from a power saving (Deactivation) state to a normal (Activation) state. The Cell Activation Request message is defined in LTE. For example, refer to 3GPP TS36.423“8.3.11 Cell Activation” for details thereof.

The control unit 150 refers to the neighboring base station information stored in the storage unit 140, and controls the network communication unit 120 to transmit the Cell Activation Request message to a neighboring base station (a handover destination candidate) when the neighboring base station (the handover destination candidate) is in a power saving state, while controlling the network communication unit 120 to omit the transmission of the Cell Activation Request message to the neighboring base station eNB (the handover destination candidate) when the neighboring base station eNB (the handover destination candidate) is not in the power saving state.

Next, details of the control unit 150 will be described. The control unit 150 includes a neighboring base station information management unit 151, a handover control unit 152, a handover time management unit 153, a handover source designation unit 154, a handover destination candidate designation unit 155, and an operation state control unit 156. Functions of each of the neighboring base station information management unit 151, the handover time management unit 153, the handover control unit 152, the handover source designation unit 154, the handover destination candidate designation unit 155, and the operation state control unit 156, for example, are performed when CPU as the control unit 150 executes a program stored in the storage unit 140.

The neighboring base station information management unit 151 manages the neighboring base station information stored in the storage unit 140. The identification information of the neighboring base station included in the neighboring base station information is called a neighbor list, and may be set by an operator at the time of installation of the self base station eNB or may be automatically set using the SON technology. The location information of the neighboring base station may be set by an operator at the time of installation of the self base station eNB or may be automatically set. For the operation state information of the neighboring base station, the neighboring base station information management unit 151 updates the operation state of the neighboring base station to the power saving state in response to the reception of power saving state notification from the neighboring base station, while updating the operation state of the neighboring base station to the normal state in response to the transmission of the Cell Activation Request message to the neighboring base station. As such power saving state notification, Deactivation Indication IE of an eNB Configuration Update message defined in LTE may be used (for example, refer to 3GPPTS 36.423 “8.3.5 eNB Configuration Update”).

The handover control unit 152 controls handover of the radio terminal UE according to a handover sequence defined in LTE. Details of the handover sequence, for example, are disclosed in 3GPP TS 36.300 V10.0.0 “10.1.2.1 Handover”, and the overview thereof will be described herein. In the case in which the self base station eNB is a handover source, the handover control unit 152 determines a base station or a cell, which is a handover destination of the radio terminal UE, on the basis of a measurement result report (called a Measurement Report) from the radio terminal UE, requests (Handover Request) the determined handover destination to perform handover, and instructs the radio terminal UE to perform handover when a positive response (called Handover Request ACK) corresponding to the handover request is notified. On the other hand, in the case in which the self base station eNB is a handover destination, the handover control unit 152 determines whether to accept the radio terminal UE according to a handover request from a neighboring base station, and notifies the neighboring base station of a positive response when it is determined to accept the radio terminal UE. As will be described below, a description will be provided mainly for the case in which the base station eNB illustrated in FIG. 2 is a handover destination.

In the first embodiment, a handover request (Handover Request) received in the network communication unit 120 from a neighboring base station includes identification information of a radio terminal UE (handover target), identification information of the neighboring base station, and information (hereinafter, first time information) indicating a time at which the radio terminal UE was handed over to the neighboring base station.

The handover time management unit 153 manages the first time information, and information (hereinafter, second time information) indicating a time at which the radio terminal UE was handed over to the self base station eNB.

The handover source designation unit 154 designates a neighboring base station eNB serving as a handover source of the radio terminal UE. For example, the handover source designation unit 154 designates the neighboring base station eNB, which is the handover source of the radio terminal UE which were handed over to the self base station eNB, on the basis of the identification information of the radio terminal UE, and the identification information of the neighboring base station included in the handover request received in the network communication unit 120. Alternatively, at the time of negotiation with the radio terminal UE in the handover, the handover source designation unit 154 may acquire information on the neighboring base station eNB serving as the handover source from the radio terminal UE, and designate the neighboring base station eNB serving as the handover source.

The handover destination candidate designation unit 155 designates a neighboring base station serving as a handover destination candidate, on the basis of the positional relation between the self base station eNB and the neighboring base station designated as the handover source by the handover source designation unit 154.

In the first embodiment, the handover destination candidate designation unit 155 acquires location information of the neighboring base station, which was designated as the handover source by the handover source designation unit 154, and location information of the base station eNB from the storage unit 140, calculates a movement direction of the radio terminal UE using each of the acquired location information, and designates the neighboring base station serving as the handover destination candidate according to the calculated movement direction.

Specifically, the handover destination candidate designation unit 155 further acquires the first time information and the second time information, calculates the movement direction and a movement speed of the radio terminal UE using the location information of the neighboring base station serving as the handover source, the location information of the self base station eNB, the first time information, and the second time information, and designates a neighboring base station within an estimated movement range of the radio terminal UE, which is determined according to the calculated movement direction and movement speed, as the neighboring base station serving as the handover destination candidate.

The operation state control unit 156 controls the network communication unit 120 to transmit the Cell Activation Request message, which is a return request for requesting return from the power saving state, to the neighboring base station designated by the handover destination candidate designation unit 155 as the handover destination candidate. Specifically, the operation state control unit 156 refers to the neighboring base station information stored in the storage unit 140, and controls the network communication unit 120 to transmit the Cell Activation Request message to the neighboring base station eNB serving as the handover destination candidate when the neighboring base station eNB designated by the handover destination candidate designation unit 155 as the handover destination candidate is in the power saving state, while controlling the network communication unit 120 to omit the transmission of the Cell Activation Request message to the neighboring base station eNB serving as the handover destination candidate when the neighboring base station eNB designated by the handover destination candidate designation unit 155 as the handover destination candidate is not in the power saving state.

(1.3) Operation Example of Mobile Communication System

Next, an operation example of the mobile communication system 1 according to the first embodiment will be described in sequence of (1.3.1) schematic operation and (1.3.2) operation sequence.

(1.3.1) Schematic Operation

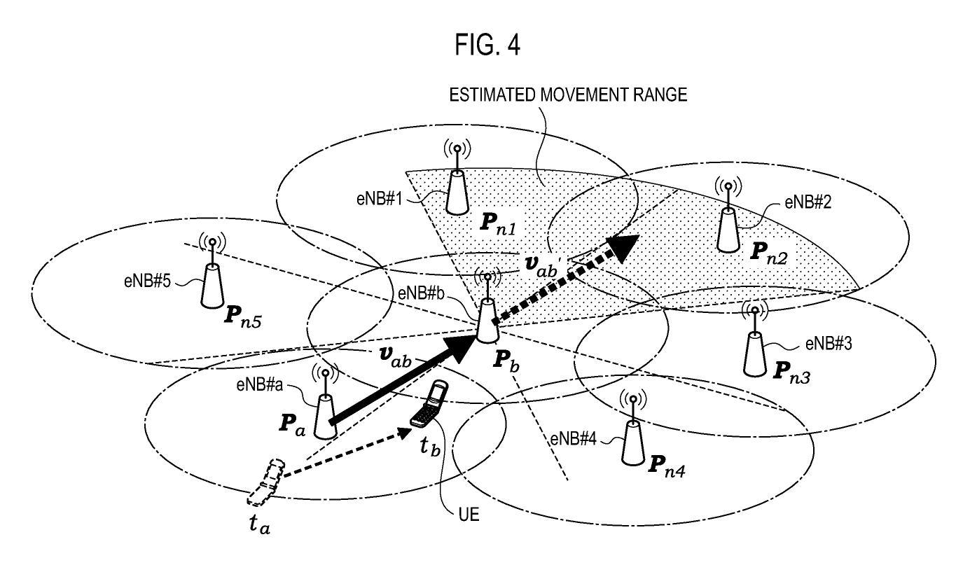

FIG. 4 is an operation concept diagram for explaining a schematic operation of the mobile communication system 1 according to the first embodiment. In the present operation example, a description will be provided for the case in which, when a base station eNB#a and neighboring base stations (eNB#b and eNB#1 to eNB#5) of the base station eNB#a are provided, a radio terminal UE moves from a communication area of the base station eNB#a to a communication area of the base station eNB#b, and is handed over from the base station eNB#a to the base station eNB#b. Furthermore, it is assumed that each of the base stations eNB#1 to eNB#5 is in the power saving state.

As illustrated in FIG. 4, the time (first time information), at which the radio terminal UE was handed over to the base station eNB#a, is set as ta, and the time (second time information), at which the radio terminal UE was handed over from the base station eNB#a to the base station eNB#b, is set as tb. Furthermore, location information of the base station eNB#a is set as Pa, location information of the base station eNB#b is set as Pb, location information of the base station eNB#1 is set as Pn1, location information of the base station eNB#2 is set as Pn2, location information of the base station eNB#3 is set as Pn3, location information of the base station eNB#4 is set as Pn4, and location information of the base station eNB#5 is set as Pn5.

Firstly, when the radio terminal UE is handed over from the base station eNB#a to the base station eNB#b, the base station eNB#a notifies the base station eNB#b of the time ta at which the radio terminal UE was handed over to the base station eNB#a.

The base station eNB#b acquires the following four types of information in the handover of the radio terminal UE.
The time ta, at which the radio terminal UE was handed over to the self base station eNB#a, which was notified from the base station eNB#a
The location Pa of the base station (the base station eNB#a) before which a particular base station from which the radio terminal UE was handed over is recognized
The time tb at which the radio terminal UE was handed over to the self base station eNB#b
The location Pb of the self base station eNB#b

The base station eNB#b calculates a terminal speed vector vab using the parameters above according to Equation 1 below, and uses the terminal speed vector vab as approximate movement direction and movement speed of the radio terminal UE.

$$\begin{matrix}[ Math . 1 ] & \\ {v}_{ab} = \frac{{P}_{b} - {P}_{a}}{{t}_{b} - {t}_{a}} & ( 1 )\end{matrix}$$

The base station eNB#b obtains an estimated movement range of the radio terminal UE within a constant time period using the estimated terminal speed vector vab and the location Pb of the self base station eNB#b, and extracts neighboring base stations within the range from the neighboring base station information. In the example of FIG. 4, since the location Pn1 of the base station eNB#1 and the location Pn2 of the base station eNB#2 are included in the estimated movement range, the base station eNB#b sets the base stations eNB#1 and eNB#2 as neighboring base stations serving as handover destination candidates.

The base station eNB#b transmits a return request from the power saving state to all the neighboring base stations extracted as the handover destination candidates.

(1.3.2) Operation Sequence

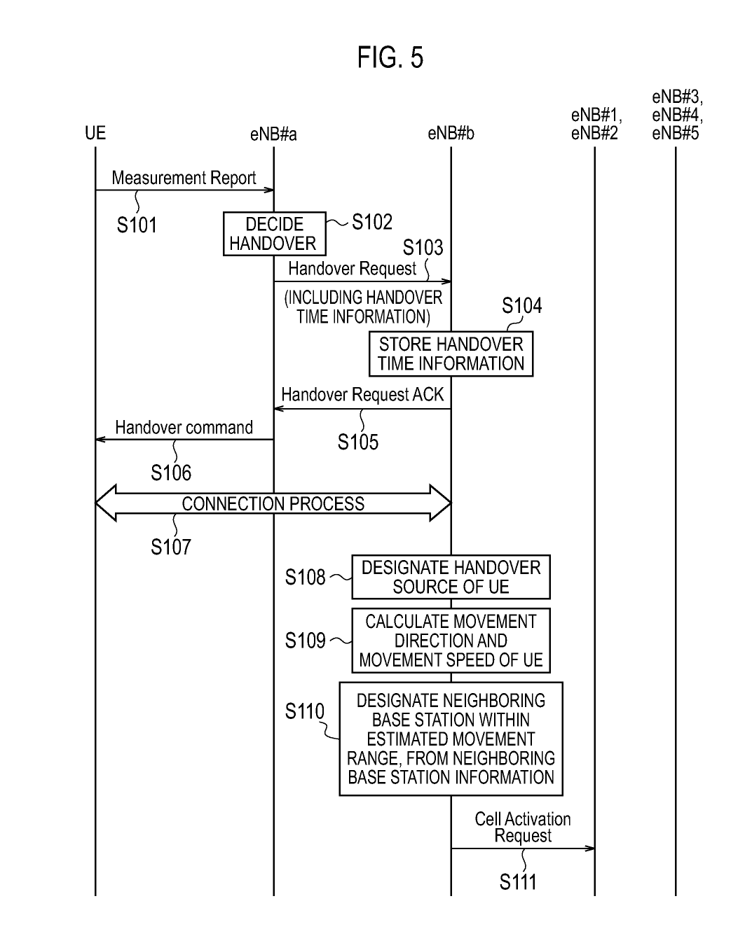

Next, the operations described using FIG. 4 will be described in detail. FIG. 5 is an operation sequence diagram for explaining a detailed operation of the mobile communication system 1 according to the first embodiment. In the present operation sequence, the operation of the base station eNB#b will be mainly described. Furthermore, in a previous step of the present operation sequence, it is assumed that the radio terminal UE was handed over to the base station eNB#a and the handover time is stored in the base station eNB#a.

In step S101, the radio terminal UE detects that a measurement result of received power (RSRP) and/or received quality (RSRQ) of a reference signal received from the base station eNB satisfied a preset report condition, and transmits a Measurement Report message indicating the measurement result to the base station eNB#a. For the base station eNB#a, examples include a condition in which RSRP of a serving cell becomes less than RSRP of a neighboring cell or a condition in which the RSRP of the serving cell becomes less than a threshold value. In addition, not only such an event trigger type report, but also a periodic report may be performed. The base station eNB#a receives the Measurement Report message.

In step S102, the base station eNB#a determines handover to the base station eNB#b on the basis of the Measurement Report message received from the radio terminal UE.

In step S103, the base station eNB#a transmits a Handover Request message to the base station eNB#b using the X2 interface, which includes information indicating the time (first time information) at which the radio terminal UE was handed over to the base station eNB#a. The network communication unit 120 of the base station eNB#b receives the Handover Request message including the first time information.

In step S104, the handover time management unit 153 of the base station eNB#b acquires the first time information included in the Handover Request message received in the network communication unit 120, and stores the first time information in the storage unit 140. Furthermore, the handover source designation unit 154 of the base station eNB#b acquires terminal identification information and base station identification information included in the Handover Request message received in the network communication unit 120, and stores the terminal identification information and the base station identification information in the storage unit 140 so as to correlate them with each other.

In step S105, the handover control unit 152 of the base station eNB#b determines whether to accept the radio terminal UE indicated by the terminal identification information included in the Handover Request message, and controls the network communication unit 120 to transmit a Handover Request ACK message to the base station eNB#a when it is determined to accept the radio terminal UE. The base station eNB#a receives the Handover Request ACK message.

In step S106, in response to the reception of the Handover Request ACK message, the base station eNB#a transmits Handover command for instructing handover to the base station eNB#b to the radio terminal UE. The radio terminal UE receives the Handover command.

In step S107, in response to the reception of the Handover command, the radio terminal UE performs a connection process with the base station eNB#b. In the connection process, the radio terminal UE notifies the base station eNB#b of the identification information of the radio terminal UE. Furthermore, the handover time management unit 153 of the base station eNB#b allows the storage unit 140 to store the time at which the radio terminal UE was handed over to the base station eNB#b, that is, information (second time information) indicating the time at which the connection process was performed.

In step S108, the handover source designation unit 154 of the base station eNB#b acquires the base station identification information correlated with the identification information of the radio terminal UE from the storage unit 140, and designates a neighboring base station indicated by the acquired base station identification information as a handover source of the radio terminal UE.

In step S109, the handover destination candidate designation unit 155 of the base station eNB#b acquires, from the storage unit 140, the location information Pa of the base station eNB#b designated as the handover source, the time (the first time information) at which the radio terminal UE was handed over to the handover source base station eNB#a, the location information of the self base station eNB#b, and the time (the second time information) at which the radio terminal UE was handed over to the self base station eNB#b. Moreover, the handover destination candidate designation unit 155 calculates the terminal speed vector vab according to Equation 1 above, and uses the terminal speed vector vab as approximate movement direction and movement speed of the radio terminal UE. Then, the handover destination candidate designation unit 155 obtains an estimated movement range of the radio terminal UE within a constant time period using the estimated terminal speed vector vab and its own location Pb.

In step S110, the handover destination candidate designation unit 155 of the base station eNB#b refers to the neighboring base station information stored in the storage unit 140, and designates a neighboring base station that is within the estimated movement range and is in the power saving state. It is assumed that the base stations eNB#1 and eNB#2 are designated.

In step S111, the operation state control unit 156 of the base station eNB#b controls the network communication unit 120 to transmit a Cell Activation Request message to the base stations eNB#1 and eNB#2 designated by the handover destination candidate designation unit 155. The network communication unit 120 transmits the Cell Activation Request message using the X2 interface, and the base stations eNB#1 and eNB#2 receive the Cell Activation Request message. After receiving the Cell Activation Request message, the base stations eNB#1 and eNB#2 return to the normal state from the power saving state.

(1.4) Effect of the First Embodiment

As described above, when the base station eNB#b detects a radio terminal UE that performed handover to the self base station eNB#b, the base station eNB#b transmits the Cell Activation Request message to the base stations eNB#1 and eNB#2 designated as handover destination candidates on the basis of the positional relation between the base station eNB#a serving as the handover source of the radio terminal UE and the self base station eNB#b. In this way, it is possible to quickly return the base stations eNB#1 and eNB#2, which are movement destination of the radio terminal UE, from the power saving state.

Furthermore, when the base stations eNB#1 and eNB#2 serving as the handover destination candidates are not in the power saving state, that is, in the normal state, the base station eNB#b omits the transmission of the Cell Activation Request message to the base stations eNB#1 and eNB#2. In this way, it is possible to avoid unnecessary transmission of the Cell Activation Request message, resulting in the reduction of a load of a network-side.

In the first embodiment, the base station eNB#b designates the base stations eNB#1 and eNB#2 as the handover destination candidates of the radio terminal UE according to the movement direction of the radio terminal UE calculated from the location information of the handover source base station eNB#a and the location information of the base station eNB#b. In this way, even when there are many neighboring base stations eNB in the vicinity of the self base station eNB#b, it is possible to designate the handover destination candidate base stations eNB#1 and eNB#2 of the radio terminal UE.

Furthermore, in the first embodiment, the base station eNB#b designates neighboring base stations within the estimated movement range of the radio terminal UE as the base stations eNB#1 and eNB#2 serving as the handover destination candidates, wherein the estimated movement range is calculated from the location information of the handover source base station eNB#a, the location information of the self base station eNB#b, the first time information, and the second information. In this way, it is possible to accurately designate the base stations eNB#1 and eNB#2 as the handover destination candidates of the radio terminal UE.

Moreover, in the first embodiment, the first time information is transmitted using the Handover Request message used in the LTE handover sequence, so that it is possible to transmit the first time information between base stations without adding a new message.

### (2) Second Embodiment

Hereinafter, the second embodiment will be described in sequence of (2.1) configuration of base station, (2.2) operation example of mobile communications system, and (2.3) effect of the second embodiment. In the second embodiment, differences from the first embodiment will be mainly described.

(2.1) Configuration of Base Station

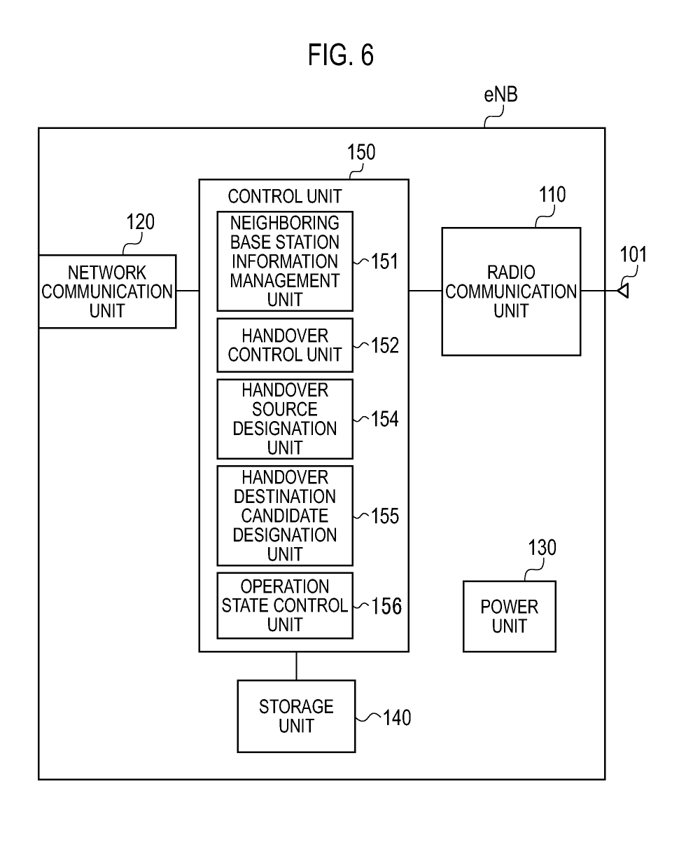

FIG. 6 is a block diagram illustrating the configuration of a base station eNB according to the second embodiment.

As illustrated in FIG. 6, the base station eNB according to the second embodiment does not include the handover time management unit 153 described in the first embodiment.

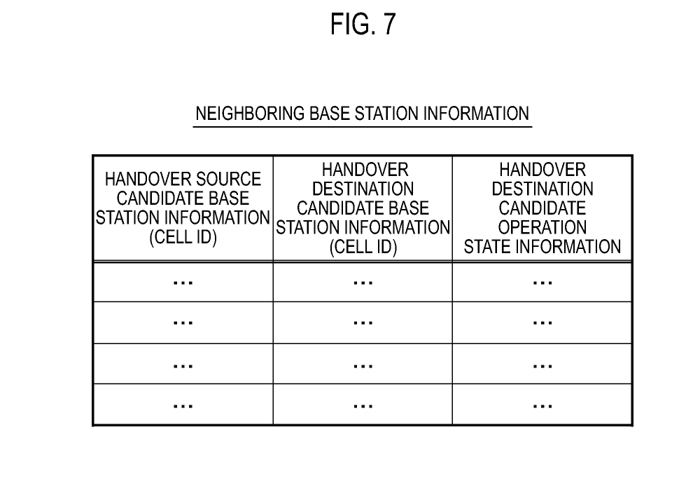

Furthermore, in the base station eNB according to the second embodiment, the storage unit 140 stores neighboring base station information illustrated in FIG. 7 as neighboring base station information on a neighboring base station. As illustrated in FIG. 7, the neighboring base station information according to the second embodiment is configured by correlating identification information of a neighboring base station serving as a handover source candidate, identification information of a neighboring base station serving as a handover destination candidate determined according to the positional relation between the neighboring base station serving as the handover source candidate and the self base station, and operation state information of the neighboring base station serving as the handover destination candidate.

As the identification information of the neighboring base station serving as the handover source candidate, a base station ID of the neighboring base station or a cell ID of a cell managed by the neighboring base station may be used. As the identification information of the neighboring base station serving as the handover destination candidate, a base station ID of the neighboring base station or a cell ID of a cell managed by the neighboring base station may be used. As the operation state information of the neighboring base station serving as the handover destination candidate, information indicating whether the neighboring base station is in a normal state or a power saving state may be used.

The identification information of the neighboring base station serving as the handover source candidate and the identification information of the neighboring base station serving as the handover source candidate may be set by an operator at the time of installation of the base station eNB or may be automatically set.

In the example of FIG. 4, when the base station eNB#b is a self base station, identification information of the base station eNB#a, as a handover source candidate, is correlated in advance with identification information of each of the base stations eNB#1 and eNB#2, as handover destination candidates, which are located opposite to the base station eNB#a with respect to the self base station eNB#b being disposed therebetween. Furthermore, identification information of the base station eNB#1, as a handover source candidate, is correlated in advance with identification information of each of the base stations eNB#a and eNB#4, as handover destination candidates, which are located opposite to the base station eNB#1 with the base station eNB#b being disposed therebetween. Moreover, identification information of the base station eNB#2, as a handover source candidate, is correlated in advance with identification information of the base station eNB#a, as a handover destination candidate, which is located opposite to the base station eNB#2 with the base station eNB#b being disposed therebetween. For the base stations eNB#3, eNB#4, and eNB#5 serving as handover source candidates, identification information of a base station serving as a handover destination candidate is correlated in advance in the same manner.

In the second embodiment, the handover destination candidate designation unit 155 refers to the storage unit 140, and designates a neighboring base station eNB as a handover destination candidate of the radio terminal UE, wherein the neighboring base station eNB corresponds to the handover source base station eNB#a designated by the handover source designation unit 154.

(2.2) Operation Example of Mobile Communications System

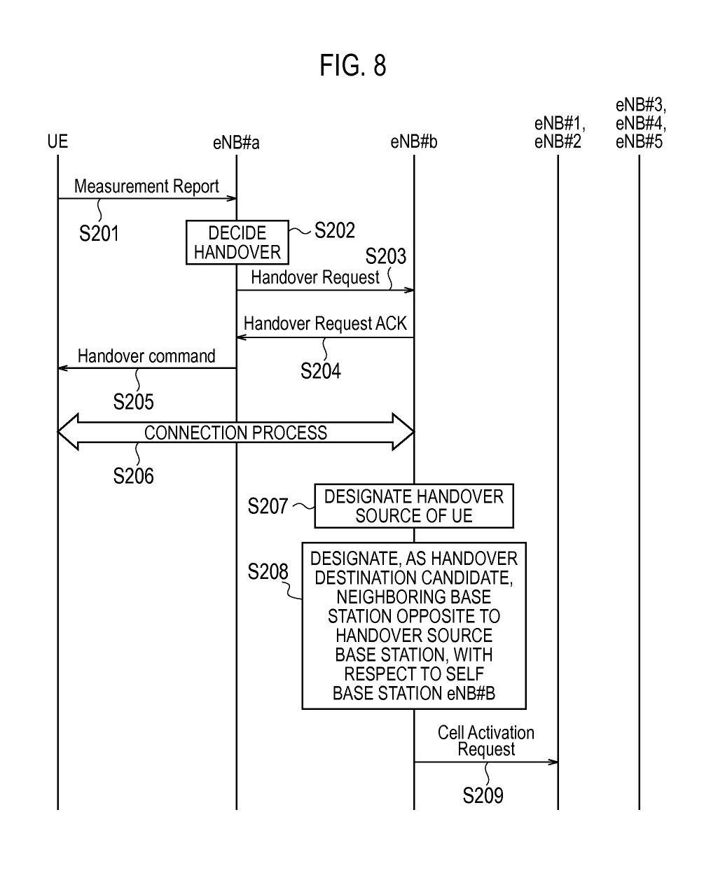

Next, an operation example of the mobile communication system 1 according to the second embodiment will be described. FIG. 8 is an operation sequence diagram for explaining an operation of the mobile communication system 1 according to the second embodiment. In the present operation sequence, the operation of the base station eNB#b (refer to FIG. 4) will be mainly described.

In step S201, the radio terminal UE detects that a measurement result of received power (RSRP) and/or received quality (RSRQ) of a reference signal received from the base station eNB satisfied a preset report condition, and transmits a Measurement Report message indicating the measurement result to the base station eNB#a. The base station eNB#a receives the Measurement Report message.

In step S202, the base station eNB#a determines handover to the base station eNB#b on the basis of the Measurement Report message received from the radio terminal UE.

In step S203, the base station eNB#a transmits a Handover Request message to the base station eNB#b using the X2 interface. The network communication unit 120 of the base station eNB#b receives the Handover Request message. The handover source designation unit 154 of the base station eNB#b acquires terminal identification information and base station identification information included in the Handover Request message received in the network communication unit 120, and stores the terminal identification information and the base station identification information in the storage unit 140 so as to correlate them with each other.

In step S204, the handover control unit 152 of the base station eNB#b determines whether to accept the radio terminal UE indicated by the terminal identification information included in the Handover Request message, and controls the network communication unit 120 to transmit a Handover Request ACK message to the base station eNB#a when it is determined to accept the radio terminal UE. The base station eNB#a receives the Handover Request ACK message.

In step S205, in response to the reception of the Handover Request ACK message, the base station eNB#a transmits Handover command for instructing handover to the base station eNB#b to the radio terminal UE. The radio terminal UE receives the Handover command.

In step S206, according to the reception of the Handover command, the radio terminal UE performs a connection process with the base station eNB#b. In the connection process, the radio terminal UE notifies the base station eNB#b of the identification information of the self radio terminal UE.

In step S207, the handover source designation unit 154 of the base station eNB#b acquires the base station identification information correlated with the identification information of the radio terminal UE from the storage unit 140, and designates a neighboring base station indicated by the acquired base station identification information as a handover source of the radio terminal UE.

In step S208, the handover destination candidate designation unit 155 of the base station eNB#b refers to the neighboring base station information stored in the storage unit 140 as described in FIG. 7, and designates the neighboring base stations eNB#1 and eNB#2 as the handover destination candidates of the radio terminal UE, wherein the base stations eNB#1 and eNB#2 are neighboring base stations corresponding to the base station eNB#a designated by the handover source designation unit 154 as the handover source and are in the power saving state.

In step S209, the operation state control unit 156 of the base station eNB#b controls the network communication unit 120 to transmit a Cell Activation Request message to the base stations eNB#1 and eNB#2 designated by the handover destination candidate designation unit 155. The network communication unit 120 transmits the Cell Activation Request message using the X2 interface, and the base stations eNB#1 and eNB#2 receive the Cell Activation Request message. After receiving the Cell Activation Request message, the base stations eNB#1 and eNB#2 return to the normal state from the power saving state.

(2.3) Effect of the Second Embodiment

As described above, according to the second embodiment, the base station eNB#b designates the base stations eNB#1 and eNB#2, which correspond to the handover source base station eNB#a and are the handover destination candidates of the radio terminal UE, using the correlation stored in advance. In this way, even when there are many base stations in the vicinity of the base station eNB#b, it is possible to designate base stations serving as the handover destination candidates of the radio terminal UE, through a simple process.

### (3) Other Embodiments

As mentioned above, the present invention has been described according to each embodiment. However, it must not be understood that the discussions and the drawings constituting a part of this disclosure limit the present invention. From this disclosure, various alternative embodiments, examples and operational techniques are apparent to those skilled in the art.

For example, in the aforementioned each embodiment, the base station eNB#b confirms whether a neighboring base station is in the power saving state and then transmits the Cell Activation Request message. However, the confirmation may be omitted. When a neighboring base station in the normal state received the Cell Activation Request message, it is sufficient if the neighboring base station transmits a Cell Activation Failure message to a transmission source of the Cell Activation Request message.

Furthermore, in the aforementioned each embodiment, the Cell Activation Request message transmitted using the X2 interface is used as the return request from the power saving state. However, other messages or information elements may be used. For example, a return request transmitted using the S1 interface may be newly defined and a mobility management device MME may relay the return request. In this way, it is possible to transmit the return request between neighboring base stations between which the X2 interface has not been established.

As mentioned above, it must be understood that the present invention includes various embodiments and the like that are not described herein. Accordingly, the present invention shall be defined only by the matters stipulating the invention of the claims that are appropriate from this disclosure. Note that the entire content of the Japanese Patent Application No. 2010-283598 (filed on Dec. 20, 2010) is incorporated herein by reference.

### INDUSTRIAL APPLICABILITY

According to the present invention, a base station and a control method thereof can be provided, with which it is possible to appropriately return a neighboring base station to a normal state.

1. A base station comprising:
a radio communication unit;
a network communication unit that is capable of communicating with neighboring base stations in the vicinity of the base station; and
a control unit that transmits a return request through the network communication unit to a neighboring base station serving as a handover destination candidate of a radio terminal, for requesting return from a power saving state.

2. The base station according to claim 1, wherein
the control unit designates the neighboring base station serving as the handover destination candidate of the radio terminal on the basis of a positional relation between the base station and a neighboring base station serving as a handover source when the radio terminal is handed over to the base station.

3. The base station according to claim 2, wherein
the control unit controls the network communication unit to transmit the return request to the neighboring base station serving as the handover destination candidate when the neighboring base station serving as the handover destination candidate is in the power saving state, and
controls the network communication unit to omit transmission of the return request to the neighboring base station serving as the handover destination candidate when the neighboring base station serving as the handover destination candidate is not in the power saving state.

4. The base station according to claim 2, further comprising:
a storage unit that stores location information of each of the neighboring base station and the base station, wherein
the control unit acquires location information of the neighboring base station serving as the handover source and location information of the base station from the storage unit,
calculates a movement direction of the radio terminal using each of the acquired location information, and
designates the neighboring base station serving as the handover destination candidate according to the calculated movement direction.

5. The base station according to claim 3, wherein
the network communication unit receives first time information from the neighboring base station serving as the handover source, the first time information indicating a time at which the radio terminal has been handed over to the neighboring base station serving as the handover source, and
the control unit further acquires the first time information and second time information indicating a time at which the radio terminal has been handed over to the base station,
calculates a movement direction and a movement speed of the radio terminal using location information of the neighboring base station serving as the handover source, location information of the base station, the first time information, and the second time information, and
designates a neighboring base station within an estimated movement range of the radio terminal as the neighboring base station serving as the handover destination candidate, the estimated movement range being determined according to the calculated movement direction and movement speed.

6. The base station according to claim 3, wherein
the first time information is transmitted from the neighboring base station serving as the handover source before the radio terminal is handed over to the base station and is included in a handover request message for requesting preparation of handover, and
the network communication unit receives the handover request message including the first time information from the neighboring base station serving as the handover source.

7. The base station according to claim 2, further comprising:
a storage unit that stores correlation between a neighboring base station serving as a handover source candidate and a neighboring base station serving as a handover destination candidate, which is determined according to a positional relation between the neighboring base station serving as the handover source candidate and the base station, wherein
the control unit refers to the storage unit, and designates a neighboring base station corresponding to the neighboring base station serving as the handover source as the neighboring base station serving as the handover destination candidate of the radio terminal.

8. A control method of a base station, which includes a radio communication unit, and a network communication unit that is capable of communicating with neighboring base stations in the vicinity of the base station, comprising:
a step of designating a neighboring base station serving as a handover source when a radio terminal is handed over to the base station;
a step of designating a neighboring base station serving as a next handover destination candidate on the basis of a positional relation between the base station and the neighboring base station serving as the handover source; and
a step of transmitting a return request to a neighboring base station serving as a handover destination candidate of the radio terminal, for requesting return from a power saving state.
